(19) United States
(12) Patent Application Publication
(10) Pub. No.: US 2024/0313570 A1
(43) Pub. Date: Sep. 19, 2024

(54) ADAPTIVE CHARGING CONTROL METHOD AND DEVICE THEREOF

(71) Applicant: SIMPLO TECHNOLOGY CO., LTD., Hsinchu County (TW)

(72) Inventor: Shu-Hung YEH, Hsinchu County (TW)

(73) Assignee: SIMPLO TECHNOLOGY CO., LTD., Hsinchu County (TW)

(21) Appl. No.: 18/344,199

(22) Filed: Jun. 29, 2023

(30) Foreign Application Priority Data
Mar. 14, 2023 (TW) 112109385

(51) Int. Cl. H02J 7/00

(52) U.S. Cl. CPC H02J 7/007194; H02J 7/00032; H02J 7/0013; H02J 7/0047; H02J 7/00714

(57) ABSTRACT

An adaptive charging control method and a device thereof are provided, in which the method compares a temperature difference of a battery pack with a charging behavior adjustment threshold value to determine whether to execute a charging current reduction adjustment algorithm or a charging current increment adjustment algorithm, and then obtains a new charging current value. Therefore, the charging behavior can be adjusted according to the temperature difference, so as to achieve the purpose of adaptive charging control and optimize the charging time and charging behavior of the battery.

### BACKGROUND

### 1. Technical Field

The present disclosure relates to a charging control technology, and more particularly, to an adaptive charging control method and device thereof.

### 2. Description of Related Art

Nowadays, electronic devices such as laptops, tablets, cellphones, smartwatches and the like have been widely used in daily life. Further, with the development of technology, consumers prefer that electronic devices can achieve a certain level of charging performance in a short period of time for convenience of use.

In this regard, in order to shorten the charging time, the prior art increases the charging speed of the electronic device by increasing the charging current: however, doing so may easily cause the temperature of the battery in the electronic device to rise rapidly to a high temperature range (e.g., 43° C. to 45° C.). For the safety of consumers, only low charging current of 0.5 C or 0.6 C can be used for charging when the charging temperature of the battery of the electronic device lands in the high temperature range, affecting the charging performance.

Therefore, how to provide the optimal charging current value in response to the temperature rise of the battery during charging to improve charging efficiency and product competitiveness and thereby greatly improving product competitiveness and meeting user requirements, has become an urgent issue to be solved in the industry.

### SUMMARY

In view of the aforementioned shortcomings of the prior art, the present disclosure provides an adaptive charging control method, which comprises: determining whether a first temperature value of a battery pack in a time interval is greater than or equal to a minimum temperature threshold value; obtaining a second temperature value of the battery pack in the time interval when the first temperature value is greater than or equal to the minimum temperature threshold value, and calculating a temperature difference in the time interval according to the first temperature value and the second temperature value: comparing whether the temperature difference is greater than a first charging behavior adjustment threshold value, wherein when the temperature difference is greater than the first charging behavior adjustment threshold value, execute a charging current reduction adjustment algorithm to calculate a gradient of charging current reduction and a first temperature compensation value of charging current, and calculate a new charging current value according to the gradient of charging current reduction and the first temperature compensation value of charging current: and comparing whether the new charging current value is greater than a minimum charging current value, and adopting the new charging current value to charge the battery pack when the new charging current value is greater than the minimum charging current value.

In the aforementioned embodiment, the present disclosure further comprises calculating the gradient of charging current reduction according to the temperature difference and a preset temperature gradient: and calculating the first temperature compensation value of charging current according to a present temperature of the battery pack and the minimum temperature threshold value.

In the aforementioned embodiment, the present disclosure further comprises calculating the new charging current value according to a present charging current value, a preset current gradient, the gradient of charging current reduction and the first temperature compensation value of charging current.

In the aforementioned embodiment, the present disclosure further comprises comparing whether the temperature difference in the time interval is less than a second charging behavior adjustment threshold value when the temperature difference is not greater than the first charging behavior adjustment threshold value.

In the aforementioned embodiment, the present disclosure further comprises executing a charging current increment adjustment algorithm when the temperature difference is less than the second charging behavior adjustment threshold value to calculate an gradient of charging current increment and a second temperature compensation value of charging current, and calculating another new charging current value according to the gradient of charging current increment and the second temperature compensation value of charging current.

In the aforementioned embodiment, the present disclosure further comprises comparing whether the another new charging current value is less than a maximum charging current value, and adopting the another new charging current value to charge the battery pack when the another new charging current value is less than the maximum charging current value.

In the aforementioned embodiment, the present disclosure further comprises calculating the gradient of charging current increment according to the temperature difference and a preset temperature gradient; and calculating the second temperature compensation value of charging current according to a present temperature of the battery pack and a maximum temperature threshold value.

In the aforementioned embodiment, the present disclosure further comprises calculating the another new charging current value according to a present charging current value, a preset current gradient, the gradient of charging current increment and the second temperature compensation value of charging current.

The present disclosure further provides an adaptive charging control device, which comprises: a battery pack comprising at least one battery: a temperature measuring device connected to the battery pack to measure a temperature value of the battery pack: a current measuring device electrically connected to the battery pack to measure a charging current value of the battery pack: and a processor electrically connected to the temperature measuring device and the current measuring device, and receiving the temperature value of the battery pack measured by the temperature measuring device and the charging current value of the battery pack measured by the current measuring device to implement the above-mentioned adaptive charging control method.

In the aforementioned embodiment, the present disclosure further comprises a communication element communicatively connected to the processor, wherein the processor controls a battery charging system via the communication element to charge the battery pack with the new charging current value.

As can be understood from the above, the adaptive charging control method and device thereof according to the present disclosure compare a first charging behavior adjustment threshold value and/or a second charging behavior adjustment threshold value by the temperature difference of the battery pack in the time interval to determine whether to execute a charging current reduction adjustment algorithm or a charging current increment adjustment algorithm, so as to obtain a new charging current value. Moreover, the adaptive charging control method of the present disclosure can make the charging current achieve a hysteresis effect, so as to avoid battery damage and poor charging efficiency caused by a great variation in charging current, and can more effectively reduce the battery temperature of the battery pack and improve the charging speed.

### BRIEF DESCRIPTION OF THE DRAWINGS

FIG. 1A is a schematic diagram of a framework of an adaptive charging control device of the present disclosure.

FIG. 1B is a diagram related to adaptive charging control of the present disclosure.

FIG. 2 is a flowchart illustrating an adaptive charging control method of the present disclosure.

FIG. 3 is a flowchart illustrating a charging current reduction adjustment method of the present disclosure.

FIG. 4 is a flowchart illustrating a charging current increment adjustment method of the present disclosure.

FIG. 5 is a schematic diagram showing the adaptive charging control behavior according to a first embodiment of the adaptive charging control method of the present disclosure.

FIG. 6 is a schematic diagram showing the adaptive charging control behavior according to a second embodiment of the adaptive charging control method of the present disclosure.

FIG. 7A is a line graph of battery charging obtained by adopting a charging method of the prior art.

FIG. 7B is a line graph of battery charging obtained by adopting the adaptive charging control method of the present disclosure.

### DETAILED DESCRIPTION

Implementations of the present disclosure are described below by embodiments. Other advantages and technical effects of the present disclosure can be readily understood by one of ordinary skill in the art upon reading the disclosure of this specification.

It should be noted that the structures, ratios, sizes shown in the drawings appended to this specification are provided in conjunction with the disclosure of this specification in order to facilitate understanding by those skilled in the art. They are not meant, in any ways, to limit the implementations of the present disclosure, and therefore have no substantial technical meaning. Without influencing the effects created and objectives achieved by the present disclosure, any modifications, changes, or adjustments to the structures, ratios, or sizes are construed as falling within the scope covered by the technical content disclosed herein. Meanwhile, terms such as “one,” “a,” “first,” “second,” “on,” “above,” “below,” and the like, are for illustrative purposes, and are not meant to limit the scope implementable by the present disclosure. Any changes or adjustments made to the relative relationships, without substantially modifying the technical content, are also to be construed as within the scope implementable by the present disclosure.

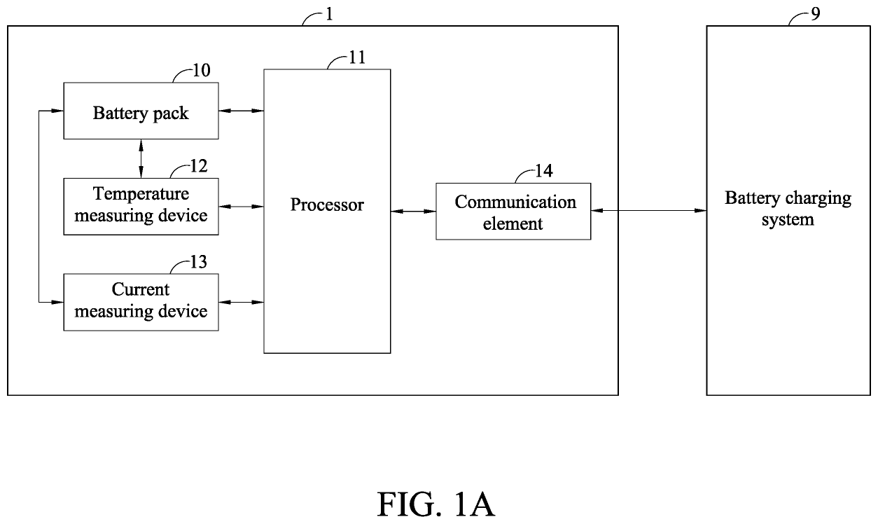

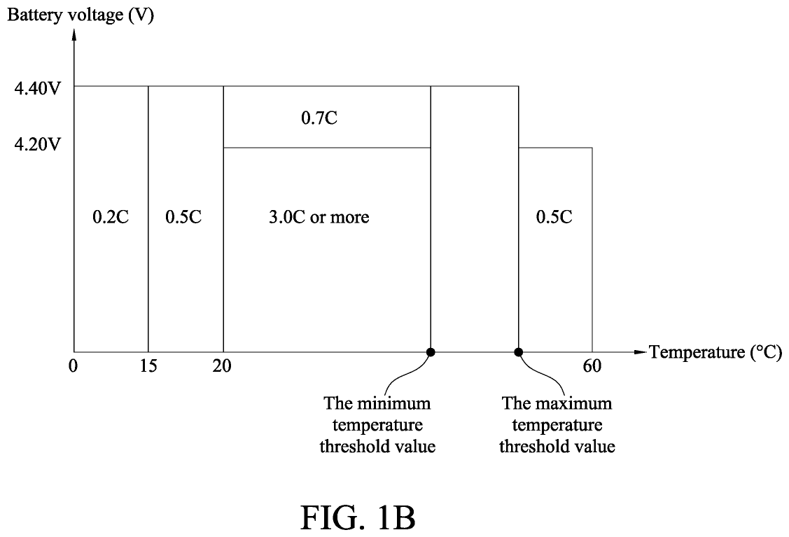

FIG. 1A is a schematic diagram of a framework of an adaptive charging control device 1 of the present disclosure. As shown in FIG. 1A, the adaptive charging control device 1 comprises: a battery pack 10, a processor 11, a temperature measuring device 12, a current measuring device 13 and a communication element 14. In addition, the adaptive charging control device 1 may comprise a register for storing battery information (such as the charging current value or temperature value of the battery pack 10).

The battery pack 10 comprises at least one battery (such as one or a plurality of batteries), wherein the battery of the battery pack 10 can be a nickel-cadmium battery (Ni—Cd), a nickel-metal hydride battery (Ni-MH), or a lithium-ion battery (Li-Ion), etc., and the battery types and battery combinations in the battery pack 10 are not limited to the above.

The processor 11 can be an electronic element with a suitable algorithm mechanism such as a central processing unit (CPU), a microprocessor, a single-chip microcomputer, etc., and the processor 11 controls the charging of the battery pack 10 according to an adaptive charging control diagram (as shown in FIG. 1B).

The temperature measuring device 12 is connected to the battery pack 10 and electrically connected to the processor 11, so that the temperature measuring device 12 measures the temperature of the battery pack 10 periodically (e.g., every 0.1 second).

The current measuring device 13 can be an ammeter and is electrically connected to the battery pack 10, so that the current measuring device 13 can measure the current value of the battery pack 10.

The communication element 14 can be a system management bus (SMBus) and is communicatively connected (or electrically connected) to the processor 11, so that the processor 11 can control an external battery charging system 9 via the communication element 14 to charge the battery pack 10. In another embodiment, the battery charging system 9 is at least composed of a charging circuit, another register and another processor and is electrically connected to the battery pack 10 to charge the battery pack 10, and the design of the battery charging system 9 is not limited to the above.

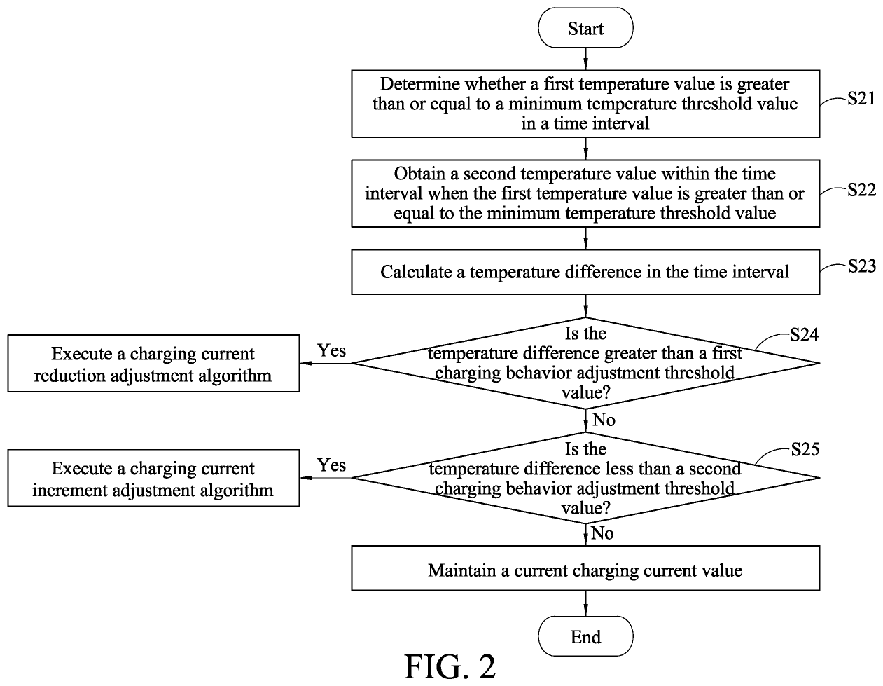

FIG. 2 is a flowchart illustrating an adaptive charging control method of the present disclosure, where an adaptive charging control algorithm is used in the adaptive charging control method so as to control the charging of the battery. FIG. 2 is illustrated with reference to FIG. 1A, and the adaptive charging control method comprises the following steps S21 to S25.

In step S21, a processor 11 receives a first temperature value of a battery pack 10 measured by a temperature measuring device 12 in a time interval, and the processor 11 determines whether the first temperature value is greater than or equal to a minimum temperature threshold value Tₜₑₘₚ₋ₘᵢₙ (as shown in FIG. 1B).

In step S22, when the processor 11 determines that the first temperature value is greater than or equal to the minimum temperature threshold value Tₜₑₘₚ₋ₘᵢₙ, the processor 11 obtains a second temperature value (the next temperature value) of the battery pack 10 measured by the temperature measuring device 12 within the time interval.

In step S23, the difference between the first temperature value and the second temperature value is calculated by the processor 11 to obtain the temperature difference Dₜₑₘₚ in the time interval.

In step S24, the processor 11 compares and determines whether the temperature difference Dₜₑₘₚ in the time interval is greater than a first charging behavior adjustment threshold value, wherein a charging current reduction adjustment algorithm (as described later) is executed if the temperature difference Dₜₑₘₚ is greater than the first charging behavior adjustment threshold value; otherwise, step S25 is executed if the temperature difference Dₜₑₘₚ is not greater than the first charging behavior adjustment threshold value.

In step S25, the processor 11 compares and determines whether the temperature difference Dₜₑₘₚ in the time interval is less than a second charging behavior adjustment threshold value, wherein a charging current increment adjustment algorithm (as described later) is executed if the temperature difference Dₜₑₘₚ is less than the second charging behavior adjustment threshold value: otherwise, the present charging current value is maintained if the temperature difference Dₜₑₘₚ is not less than the second charging behavior adjustment threshold value.

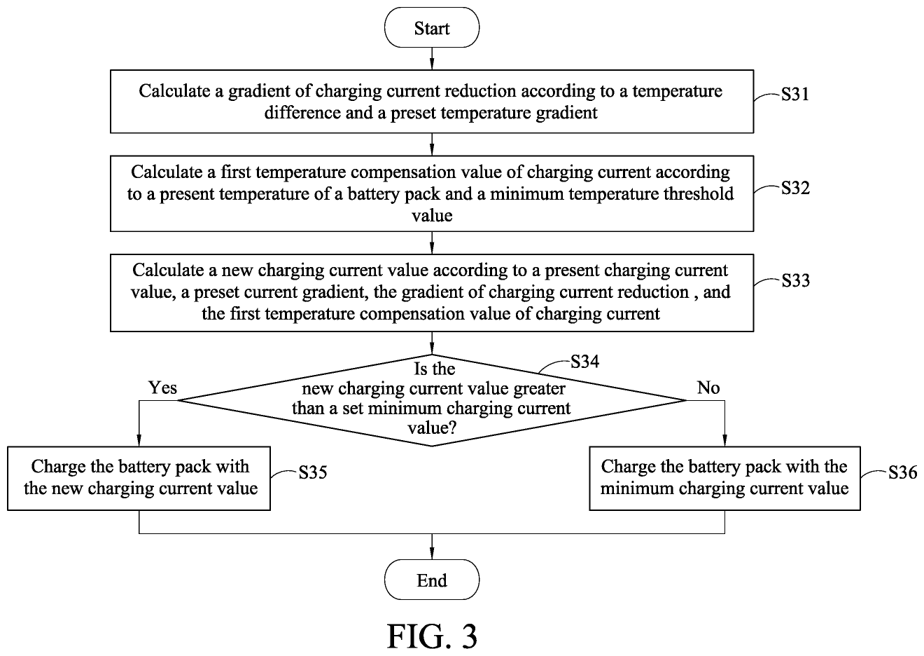

FIG. 3 is a flowchart illustrating a charging current reduction adjustment method of the present disclosure, where a charging current reduction adjustment algorithm is used in the charging current reduction adjustment method so as to control the charging of the battery, and FIG. 3 is illustrated with reference to FIG. 1A to FIG. 2. In addition, the charging current reduction adjustment method follows the above step S24, and the charging current reduction adjustment method comprises the following steps S31 to S36.

In step S31, the processor 11 calculates a gradient of charging current reduction according to the temperature difference Dₜₑₘₚ and a preset temperature gradient by using a gradient of reduction formula (1), wherein the gradient of reduction formula (1) is as follows:

$$gradient of charging current reduction = \frac{temperature difference}{preset temperature gradient} \qquad ( 1 )$$

In step S32, the processor 11 calculates a first temperature compensation value of charging current according to the present temperature (such as the second temperature value) of the battery pack 10 and the minimum temperature threshold value Tₜₑₘₚ₋ₘᵢₙ by using a reduction temperature compensation formula (2), wherein the reduction temperature compensation formula (2) is as follows:

$$first temperature compensation value of charging current = 1 + ( \frac{present temperature - minimum temperature threshold value}{first temperature compensation factor} ) \qquad ( 2 )$$

In step S33, the processor 11 calculates a new charging current value according to a present charging current value, a preset current gradient, the gradient of charging current reduction, and the first temperature compensation value of charging current by using a charging current reduction adjustment formula (3), wherein the charging current reduction adjustment formula (3) is as follows:

$$new charging current value = present charging current value - ( preset current gradient \times gradient of charging current reduction \times first temperature compensation value of charging current ) \qquad ( 3 )$$

In step S34, the processor 11 compares and determines whether the new charging current value is greater than a set minimum charging current value, wherein step S35 is executed if the new charging current value is greater than the minimum charging current value; otherwise, step S36 is executed if the new charging current value is less than the minimum charging current value.

In step S35, the processor 11 controls a battery charging system 9 via a communication element 14 to charge the battery pack 10 with the new charging current value.

In step S36, the processor 11 controls the battery charging system 9 via the communication element 14 to charge the battery pack 10 with the minimum charging current value.

Therefore, the higher the temperature of the battery pack 10 is, the farther the temperature is away from the minimum temperature threshold value Tₜₑₘₚ₋ₘᵢₙ, which results in a higher first temperature compensation value of the charging current, and a lower calculated new charging current: as such, the battery pack 10 is charged with the lower new charging current value, making the temperature of the battery pack 10 drop. However, the battery pack 10 also has the minimum charging current value, so that the battery pack 10 is charged with the minimum charging current value when the new charging current value is less than the minimum charging current value.

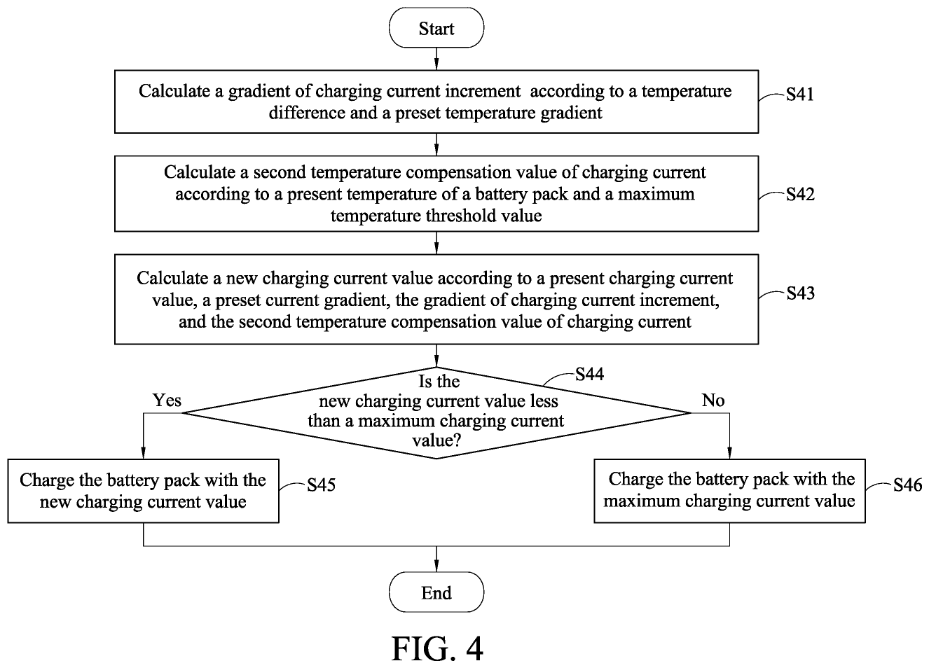

FIG. 4 is a flowchart illustrating a charging current increment adjustment method of the present disclosure, where a charging current increment adjustment algorithm is used in the charging current increment adjustment method so as to control the charging of the battery, and FIG. 4 is illustrated with reference to FIG. 1A to FIG. 2. In addition, the charging current increment adjustment method follows the above step S25, and the charging current increment adjustment method comprises the following steps S41 to S46.

In step S41, the processor 11 calculates a gradient of charging current increment according to the temperature difference Dₜₑₘₚ and the preset temperature gradient by using a gradient of increment formula (4), wherein the gradient of increment formula (4) is as follows:

$$gradient of charging current increment = \frac{temperature difference}{preset temperature gradient} \qquad ( 4 )$$

In step S42, the processor 11 calculates a second temperature compensation value of charging current according to the present temperature (such as the second temperature value) of the battery pack 10 and the maximum temperature threshold value Tₜₑₘₚ₋ₘₐₓ by using an increment temperature compensation formula (5), wherein the increment temperature compensation formula (5) is as follows:

$$second temperature compensation value of charging current = 1 + ( \frac{the maximum temperature threshold value - present temperature}{second temperature compensation factor} ) \qquad ( 5 )$$

In step S43, the processor 11 calculates a new charging current value according to a present charging current value, a preset current gradient, the gradient of charging current increment, and the second temperature compensation value of charging current by using a charging current increment adjustment formula (6), wherein the charging current increment adjustment formula (6) is as follows:

$$new charging current value = present charging current value + ( preset current gradient \times gradient of charging current increment \times second temperature compensation value of charging current ) \qquad ( 6 )$$

In step S44, the processor 11 compares and determines whether the new charging current value is less than a set maximum charging current value, wherein step S45 is executed if the new charging current value is less than the maximum charging current value; otherwise, step S46 is executed if the new charging current value is greater than the maximum charging current value.

In step S45, the processor 11 controls the battery charging system 9 via the communication element 14 to charge the battery pack 10 with the new charging current value.

In step S46, the processor 11 controls the battery charging system 9 via the communication element 14 to charge the battery pack 10 with the maximum charging current value.

Therefore, the lower the temperature of the battery pack 10 is, the farther the temperature is away from the maximum temperature threshold value Tₜₑₘₚ₋ₘₐₓ, which results rising both in the second temperature compensation values of charging current and the calculated new charging current: as such, the battery pack 10 is charged with a higher new charging current value, making the charging speed of the battery pack 10 increased. However, the battery pack 10 also has the maximum charging current value, so that the battery pack 10 is charged with the maximum charging current value when the new charging current value is greater than the maximum charging current value.

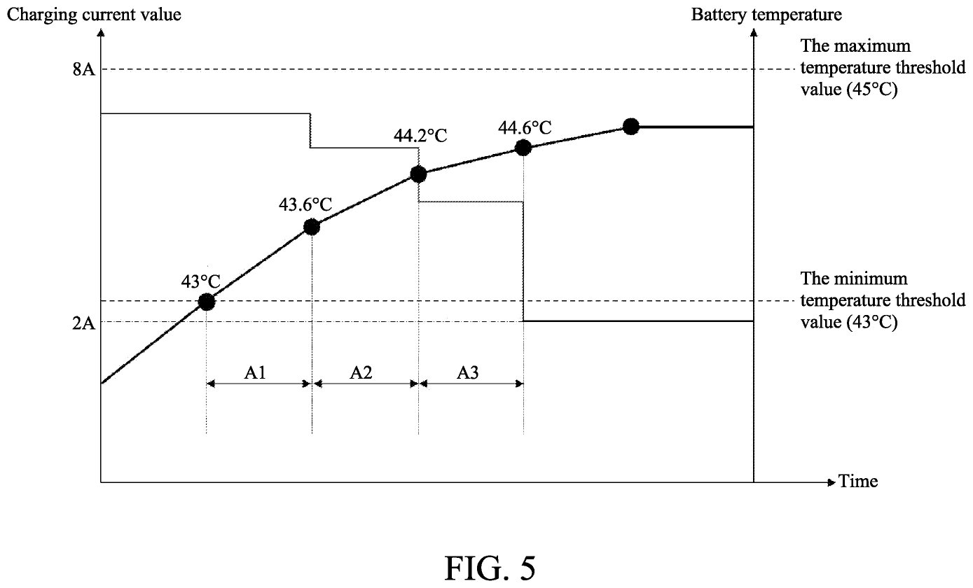

FIG. 5 is a schematic diagram showing the adaptive charging control behavior according to a first embodiment of the adaptive charging control method of the present disclosure, and FIG. 5 is illustrated with reference to FIG. 1A to FIG. 3. In addition, parts of the first embodiment that are the same as the above-mentioned embodiments will not be repeated.

In an embodiment, a temperature measuring device 12 measures a first temperature value (43° C.) of a battery pack 10 in a first time interval A1, and the temperature measuring device 12 provides the first temperature value (43° C.) to a processor 11, and the processor 11 determines that the first temperature value is equal to a minimum temperature threshold value Tₜₑₘₚ₋ₘᵢₙ (43° C.), so the processor 11 receives a second temperature value (43.6° C.) (the next temperature value) of the battery pack 10 measured by the temperature measuring device 12 in the first time interval A1.

Then, the processor 11 calculates the difference between the first temperature value and the second temperature value, for example: the second temperature value (43.6° C.)−first temperature value (43°° C.)=0.6° C., to obtain the temperature difference Dₜₑₘₚ (0.6° C.) in the first time interval A1. Thereby, the processor 11 compares and determines whether the temperature difference Dₜₑₘₚ (0.6° C.) in the first time interval A1 is greater than a first charging behavior adjustment threshold value, and the processor 11 executes a charging current reduction adjustment algorithm when the temperature difference Dₜₑₘₚ (0.6° C.) is greater than the first charging behavior adjustment threshold value (e.g., 0.3° C.).

Specifically, the processor 11 calculates a gradient of charging current reduction according to the temperature difference Dₜₑₘₚ (0.6° C.) and a preset temperature gradient (0.2° C.) by using a gradient of reduction formula (1), for example: the gradient of charging current reduction=0.6° C./0.2° C.=3. Then the processor 11 calculates the first temperature compensation value of charging current according to the present temperature (such as the second temperature value) and the minimum temperature threshold value Tₜₑₘₚ₋ₘᵢₙ using a reduction temperature compensation formula (2), for example, the first temperature compensation factor is 2, and the first temperature compensation value of charging current=1+((43.6° C.−43° C.)/2)=1.3.

Afterwards, the processor 11 calculates a new charging current value according to a present charging current value (8 A), a preset current gradient (0.5 A), the gradient of reduction formula (3) of charging current, and the first temperature compensation value (1.3) of charging current by using a charging current reduction adjustment formula (3), for example: the new charging current value=8 A−(0.5 A×3×1.3)=8 A−1.95 A=6.05 A, wherein 1.95 A is the reduction value of the charging current.

Finally, the processor 11 confirms that the new charging current value (6.05 A) is greater than a set minimum charging current value (e.g., 2 A), so the processor 11 controls a battery charging system 9 via a communication element 14 to charge the battery pack 10 with the new charging current value (6.05 A).

In another embodiment, the temperature measuring device 12 then measures the next temperature value (44.2° C.) of the battery pack 10 in a second time interval A2 to be defined as the second temperature value, while the previous temperature value (43.6° C.) is defined as a first temperature value, and the temperature difference Dₜₑₘₚ (0.6° C.=44.2° C.−43.6° C.) in the second time interval A2 is still greater than the first charging behavior adjustment threshold value (e.g., 0.3° C.). Therefore, according to the above charging current reduction algorithm, the gradient of reduction formula ((44.2° C.−43.6° C.)/0.2° C.=3) of charging current and the first temperature compensation value (1+(44.2° C.−43° C.)/2=1.6) of charging current are calculated, and then the next new charging current value (6.05 A−(0.5 A×3×1.6)=6.05 A−2.4 A=3.65 A) is calculated, so that the battery charging system 9 charges the battery pack 10 with the new charging current value (3.65 A).

In yet another embodiment, the temperature measuring device 12 continues to measure the next temperature value (44.6° C.) of the battery pack 10 in a third time interval A3, and the next temperature value is defined as the second temperature value, while the previous temperature value (44.2° C.) is defined as the first temperature value. Although the temperature increment of the second temperature value (44.6° C.) has a downward trend, the temperature difference Dₜₑₘₚ (0.4° C.=44.6° C.−44.2° C.) in the third time interval A3 is also greater than the first charging behavior adjustment threshold value (e.g., 0.3° C.). Therefore, according to the above-mentioned charging current reduction adjustment algorithm, the gradient of charging current reduction (2=(44.6°° C.−44.2° C.)/0.2° C.)and the first temperature compensation value (1.8=1+(44.6°° C.−43° C.)/2) of charging current are calculated, and then the next new charging current value (0.95 A=3.65 A−(0.5 A×3×1.8)=3.65 A−2.7 A) is calculated. However, the new charging current value (0.95 A) is less than the minimum charging current value (e.g., 2 A), so the processor 11 controls the battery charging system 9 to charge the battery pack 10 with the minimum charging current value (e.g., 2 A).

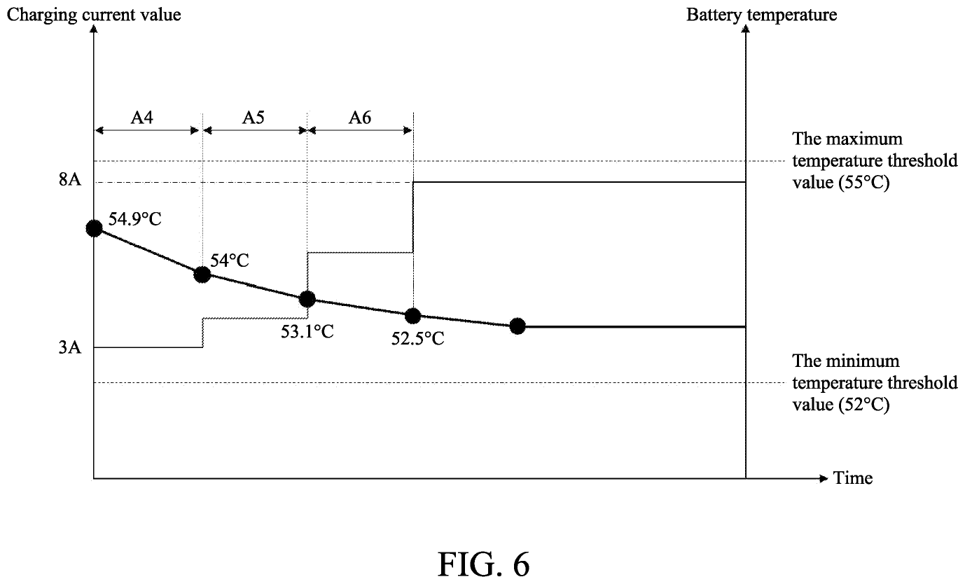

FIG. 6 is a schematic diagram showing the adaptive charging control behavior according to a second embodiment of the adaptive charging control method of the present disclosure, and FIG. 6 is illustrated with reference to FIG. 1A to FIG. 2 and FIG. 4. In addition, parts of the second embodiment that are the same as the above-mentioned embodiments will not be repeated.

In an embodiment, a temperature measuring device 12 measures a third temperature value (54.9°° C.) of a battery pack 10 in a fourth time interval A4, and the temperature measuring device 12 provides the third temperature value (54.9° C.) to a processor 11, and the processor 11 determines that the third temperature value is greater than a minimum temperature threshold value Tₜₑₘₚ₋ₘᵢₙ (52° C.), so the processor 11 receives the fourth temperature value (54° C.) (the next temperature value) of the battery pack 10 in the fourth time interval A4 measured by the temperature measuring device 12.

Then, the processor 11 calculates the difference between the third temperature value and the fourth temperature value, for example: the third temperature value (54.9° C.)−fourth temperature value (54° C.)=0.9° C., to obtain the temperature difference Dₜₑₘₚ (0.9° C.) in the fourth time interval A4. Thereby, the processor 11 compares and determines whether the temperature difference Dₜₑₘₚ (0.9° C.) in the fourth time interval A4 is greater than a first charging behavior adjustment threshold value, and the processor 11 compares and determines whether the temperature difference Dₜₑₘₚ (0.9° C.) is less than a second charging behavior adjustment threshold value when the temperature difference Dₜₑₘₚ (0.9° C.) is less than the first charging behavior adjustment threshold value (e.g., 1.5° C.), and the processor 11 executes a charging current increment adjustment algorithm when the temperature difference Dₜₑₘₚ (0.9° C.) is less than the second charging behavior adjustment threshold value (e.g., 1° C.).

Specifically, the processor 11 calculates an gradient of charging current increment according to the temperature difference Dₜₑₘₚ (0.9° C.) and the preset temperature gradient (0.3° C.) by using a gradient of increment formula (4), for example: the gradient of charging current increment=0.9° C./0.3° C.=3. Then the processor 11 calculates the second temperature compensation value of charging current according to the present temperature (such as the fourth temperature value) and the maximum temperature threshold value Tₜₑₘₚ₋ₘₐₓ using an increment temperature compensation formula (5), for example, the second temperature compensation factor is 4, and the second temperature compensation value of charging current=1+((55° C. −54° C.)/4)=1.25.

Afterwards, the processor 11 calculates a new charging current value according to a present charging current value (3 A), a preset current gradient (0.5 A), the gradient of increment (3) of charging current, and the second temperature compensation value (1.25) of charging current by using a charging current increment adjustment formula (6), for example: the new charging current value=3 A+(0.5 A×3×1.25)=3A+1.875 A≅4.88 A, wherein 1.875 A is the increment value of the charging current.

Finally, the processor 11 confirms that the new charging current value (4.88 A) is less than a set maximum charging current value (e.g., 8 A), so the processor 11 controls a battery charging system 9 via a communication element 14 to charge the battery pack 10 with the new charging current value (4.88 A).

In another embodiment, the temperature measuring device 12 then measures the next temperature value (53.1° C.) of the battery pack 10 in a fifth time interval A5 to be defined as the fourth temperature value, while the previous temperature value (54° C.) is defined as a third temperature value, and the temperature difference Dₜₑₘₚ (0.9° C.=54° C.−53.1° C.) in the fifth time interval A5 is still less than the first charging behavior adjustment threshold value (e.g., 1.5° C.) and the second charging behavior adjustment threshold value (e.g., 1° C.). Therefore, according to the above charging current increment adjustment algorithm, the gradient of charging current increment (3=(54° C.−53.1° C.)/0.3° C.) and the second temperature compensation value (1.475=1+(55° C.−53.1° C.)/4) of charging current are calculated, and then the next new charging current value (7.09 A=4.88 A+(0.5 A×3×1.475)=4.88 A+2.21 A) is calculated, so that the battery charging system 9 charges the battery pack 10 with the new charging current value (7.09 A).

In yet another embodiment, the temperature measuring device 12 continues to measure the next temperature value (52.5° C.) of the battery pack 10 in a sixth time interval A6, and the next temperature value is defined as the fourth temperature value, while the previous temperature value (53.1° C.) is defined as the third temperature value. Although the new charging current value has been increased, the temperature increment of the fourth temperature value (52.5° C.) still has a downward trend, and the temperature difference Dₜₑₘₚ (0.6° C.=53.1° C.−52.5° C.) in the fifth time interval A5 is also less than the first charging behavior adjustment threshold value (e.g., 1.5° C.) and the second charging behavior adjustment threshold value (e.g., 1° C.). Therefore, according to the above-mentioned charging current increment adjustment algorithm, the gradient of charging current increment (2=(53.1° C.−52.5° C.)/0.3° C.) and the second temperature compensation value (1.625=1+((55° C.−52.5° C.)/4)) of charging current are calculated, and then the next new charging current value (8.72 A=7.09 A+(0.5 A×2×1.625)=7.09 A+1.625 A) is calculated. However, the new charging current value (8.72 A) is greater than the maximum charging current value (e.g., 8 A), so the processor 11 controls the battery charging system 9 to charge the battery pack 10 with the maximum charging current value (e.g., 8 A).

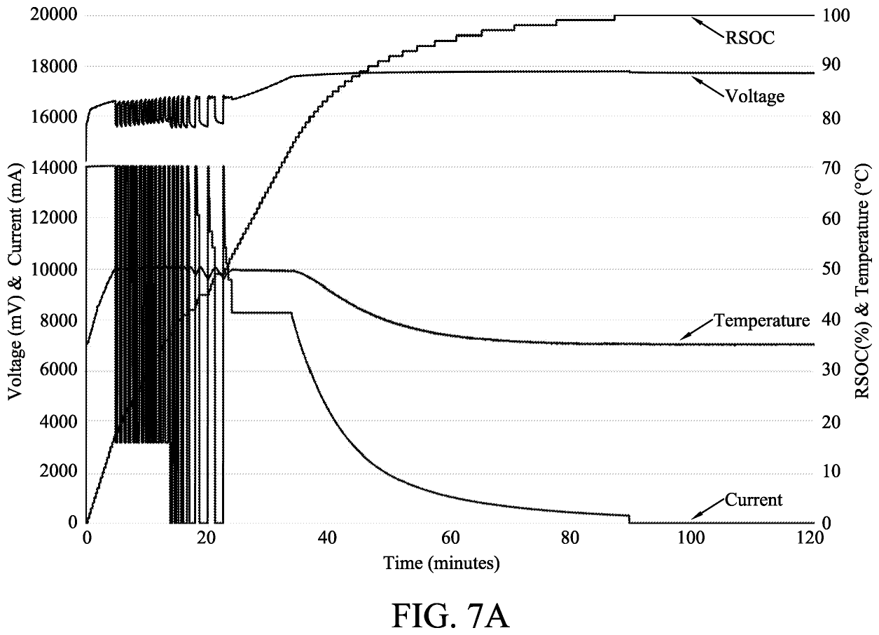

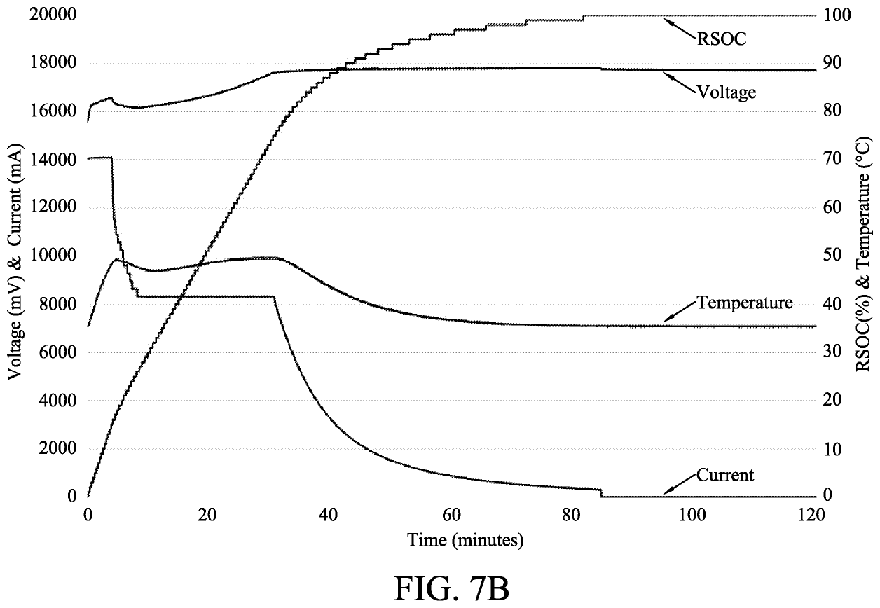

FIG. 7A is a line graph of battery charging obtained by adopting a charging method of the prior art, and FIG. 7B is a line graph of battery charging obtained by adopting the adaptive charging control method of the present disclosure.

As shown in FIG. 7A, in the prior art, when the charging current value is merely adjusted according to the temperature threshold value, the charging current value changes rapidly, resulting in severe jitter, and the battery pack 10 is prone to aging. Moreover, as shown in Table 1 below, the prior art can't effectively reduce the maximum battery temperature of the battery pack 10, which affects the charging speed of the battery pack 10 and causing it to take more time to reach the target RSOC (Relative State-Of-Charge).

TABLE 1

| | Maximum | | | | |
|---|---|---|---|---|---|
| | battery | | | | |
| | temperature | | RSOC (30%) | RSOC (40%) | RSOC (50%) |
| The prior art | 50° | C. | 10.4 mins | 15.75 mins | 23.3 mins |
| The present | 49.2° | C. | 9.95 mins | 14.5 mins | 19.1 mins |
| disclosure | | | | | |

In contrast to the prior art, as shown in FIG. 7B, the adaptive charging control method (or adaptive charging control algorithm) of the present disclosure can make the charging current achieve a hysteresis effect, so as to avoid battery damage and poor charging efficiency caused by a great fluctuation in charging current, and can effectively reduce the maximum battery temperature of the battery pack 10 and improve the charging speed.

In view of the above, the adaptive charging control method and device thereof according to the present disclosure compare the temperature difference of the battery pack in the time interval with a first charging behavior adjustment threshold value and/or a second charging behavior adjustment threshold value to determine whether executing a charging current reduction adjustment algorithm or a charging current increment adjustment algorithm to obtain a new charging current value. Therefore, the present disclosure detects the temperature difference of the battery pack in real time, and adjusts the charging behavior according to the temperature difference, thereby achieving the purpose of adaptive charging control. Moreover, the present disclosure takes the difference of battery temperature reduction and increment during using into consideration, and performs adaptive charging behavior adjustment, so as to achieve the optimization of battery charging time and charging behavior.

The above embodiments are provided for illustrating the principles of the present disclosure and its technical effect, and should not be construed as to limit the present disclosure in any way. The above embodiments can be modified by one of ordinary skill in the art without departing from the spirit and scope of the present disclosure. Therefore, the scope claimed of the present disclosure should be defined by the following claims.

What is claimed is:

1. An adaptive charging control method, comprising:
determining whether a first temperature value of a battery pack in a time interval is greater than or equal to a minimum temperature threshold value:
obtaining a second temperature value of the battery pack in the time interval when the first temperature value is greater than or equal to the minimum temperature threshold value, and calculating a temperature difference in the time interval according to the first temperature value and the second temperature value:
comparing whether the temperature difference is greater than a first charging behavior adjustment threshold value, wherein when the temperature difference is greater than the first charging behavior adjustment threshold value, execute a charging current reduction adjustment algorithm to calculate a gradient of charging current reduction and a first temperature compensation value of charging current, and calculate a new charging current value according to the gradient of charging current reduction and the first temperature compensation value of charging current; and
comparing whether the new charging current value is greater than a minimum charging current value, and adopting the new charging current value to charge the battery pack when the new charging current value is greater than the minimum charging current value.

2. The adaptive charging control method of claim 1, further comprising:
calculating the gradient of charging current reduction according to the temperature difference and a preset temperature gradient: and
calculating the first temperature compensation value of charging current according to a present temperature of the battery pack and the minimum temperature threshold value.

3. The adaptive charging control method of claim 1, further comprising calculating the new charging current value according to a present charging current value, a preset current gradient, the gradient of charging current reduction and the first temperature compensation value of charging current.

4. The adaptive charging control method of claim 1, further comprising comparing whether the temperature difference in the time interval is less than a second charging behavior adjustment threshold value when the temperature difference is not greater than the first charging behavior adjustment threshold value.

5. The adaptive charging control method of claim 4, further comprising executing a charging current increment adjustment algorithm when the temperature difference is less than the second charging behavior adjustment threshold value to calculate an gradient of charging current increment and a second temperature compensation value of charging current, and calculating another new charging current value according to the gradient of charging current increment and the second temperature compensation value of charging current.

6. The adaptive charging control method of claim 5, further comprising comparing whether the another new charging current value is less than a maximum charging current value, and adopting the another new charging current value to charge the battery pack when the another new charging current value is less than the maximum charging current value.

7. The adaptive charging control method of claim 5, further comprising:
calculating the gradient of charging current increment according to the temperature difference and a preset temperature gradient; and
calculating the second temperature compensation value of charging current according to a present temperature of the battery pack and a maximum temperature threshold value.

8. The adaptive charging control method of claim 5, further comprising calculating the another new charging current value according to a present charging current value, a preset current gradient, the gradient of charging current increment and the second temperature compensation value of charging current.

9. An adaptive charging control device, comprising:
a battery pack comprising at least one battery;
a temperature measuring device connected to the battery pack to measure a temperature value of the battery pack;
a current measuring device electrically connected to the battery pack to measure a charging current value of the battery pack; and
a processor electrically connected to the temperature measuring device and the current measuring device, and receiving the temperature value of the battery pack measured by the temperature measuring device and the charging current value of the battery pack measured by the current measuring device to implement the adaptive charging control method of claim 1.

10. The adaptive charging control device of claim 9, further comprising a communication element communicatively connected to the processor, wherein the processor controls a battery charging system via the communication element to charge the battery pack with the new charging current value.
